(19) United States
(12) Patent Application Publication
(10) Pub. No.: US 2009/0100126 A1
(43) Pub. Date: Apr. 16, 2009

(54) SYSTEMS AND METHODS FOR MANAGING A SERVICE REGISTERED ON A DEVICE

(75) Inventors: Andrew R. Ferlitsch, Camas, WA (US); Stephen W. Ellis, Portland, OR (US)

Correspondence Address: AUSTIN RAPP & HARDMAN, 15 WEST SOUTH TEMPLE, SUITE 900, SALT LAKE CITY, UT, 84101, US

(73) Assignee: Sharp Laboratories of America, Inc., Camas, WA (US)

(21) Appl. No.: 11/873,285

(22) Filed: Oct. 16, 2007

(51) Int. Cl. G06F 15/16

(52) U.S. Cl. 709/203

(57) ABSTRACT

A method for managing a service registered on a device is described. A device and a service associated with the device are discovered. The validity of a server hosting the service is verified. The validity of a link corresponding to the service hosted on the server is verified. The compatibility of the service with the device is verified.

### TECHNICAL FIELD

The present invention relates generally to computers and computer-related technology. More specifically, the present invention relates to systems and methods for managing a service registered on a device.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, a typical desktop computer, such as an IBM-PC compatible, etc.

Printers are used with computers to print various kinds of items including letters, documents, pictures, etc. Many different kinds of printers are commercially available. Ink jet printers and laser printers are fairly common among computer users. Ink jet printers propel droplets of ink directly onto the paper. Laser printers use a laser beam to print.

Printers are a type of imaging device. Imaging devices include, but are not limited to, physical printers, multi-functional peripherals, a printer pool, a printer cluster, a fax machine, a plotter, a scanner, a logical device, an electronic whiteboard, a tablet PC, a computer monitor, a file, etc.

Different kinds of computer software facilitate the use of imaging devices. The computer or computing device that will be used to print the materials typically has one or more pieces of software running on the computer that enable it to send the necessary information to the printer to enable printing of the materials. If the computer or computing device is on a computer network there may be one or more pieces of software running on one or more computers on the computer network that facilitate printing.

Device management applications may manage these devices. Services associated with the devices may enhance the functionality of these devices. The services may be used to provide automatic link checking of web sites associated with the devices. However, these device management applications only manage the physical device and the services are limited to web sites only and are limited to checking if a link is found on the web sites. As such, benefits may be realized by providing improved systems and methods for managing services registered on a device.

### BRIEF DESCRIPTION OF THE DRAWINGS

FIG. 1 is a block diagram illustrating one embodiment of a computing device including a service check component in accordance with the present systems and methods;

FIG. 2 illustrates one embodiment of an operating environment of the present systems and methods;

FIG. 3 is a block diagram illustrating an embodiment of a discovery module and a verification module;

FIG. 4 is a flow diagram illustrating one embodiment of a method for managing a service registered on a device;

FIG. 5 is a diagram illustrating a process of performing a service check;

FIG. 6 is a thread diagram illustrating one embodiment of a service check to periodically check the status of a server hosting a service;

FIG. 7 is a thread diagram illustrating one embodiment of a service check that implements a link check;

FIG. 8 is a thread diagram illustrating a service check performing a site compatibility check;

FIG. 9 is a block diagram illustrating the major hardware components typically utilized with embodiments herein; and

FIG. 10 is a network block diagram illustrating one possible environment in which the present systems and methods may be implemented.

### DETAILED DESCRIPTION

A method for managing a service registered on a device is described. A device and a service associated with the device are discovered. The validity of a server hosting the service is verified. The validity of a link corresponding to the service hosted on the server is verified. The compatibility of the service with the device is verified.

In one embodiment, the server hosting the service is verified to be accessible from a network including the device. The server hosting the service may also be verified to be operational. The device may be verified to have access rights to the server hosting the service. The link may be verified to exist on the server hosting the service. The device may be verified to have access rights to the service that is hosted on the server. An application associated with the link may be verified to be capable of being initiated.

In one embodiment, the contents of the link are parsed according to one or more service language formats supported by the device. A syntax check may be performed on the passed contents to determine if the parsed contents are supported by the device.

An interface of the link is verified to be compatible with the device. A semantics check may also be performed on the link to verify compatibility with the device. The device may be a multifunction peripheral (MFP). The service may be a web service.

A computing device that is configured to manage a service registered on the computing device is also described. The computing device includes a processor and memory in electronic communication with the processor. Instructions are stored in the memory. A device and a service associated with the device are discovered. The validity of a server hosting the service is verified. The validity of a link corresponding to the service hosted on the server is verified. The compatibility of the service with the device is verified.

A computer-readable medium including executable instructions is also described. A device and a service associated with the device are discovered. The validity of a server hosting the service is verified. The validity of a link corresponding to the service hosted on the server is verified. The compatibility of the service with the device is verified.

Several exemplary embodiments are now described with reference to the Figures. This detailed description of several exemplary embodiments, as illustrated in the Figures, is not intended to limit the scope of the claims.

The word “exemplary” is used exclusively herein to mean “serving as an example, instance or illustration.” Any embodiment described as “exemplary” is not necessarily to be construed as preferred or advantageous over other embodiments.

As used herein, the terms “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments,” unless expressly specified otherwise.

The term “determining” (and grammatical variants thereof) is used in an extremely broad sense. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Device management applications are being developed to manage a multifunction peripheral (MFP) device. An example of a device management application may be a printer administration utility (PAU). In addition, server based imaging software has been developed that enhances the functionality of the MFP devices. Accordingly, benefits may be realized by adding functionality to device management tools to manage software that augments the functionality of the MFP device (e.g., Sharp Open System Architecture (OSA) applications).

Typically, a PAU tool only monitors the physical MFP devices. The PAU tool generally uses a discovery means (e.g., simple network management protocol (SNMP) discovery) to discover MFP devices within a customers' network. Once discovered, the PAU may periodically check (or sweep) through all the discovered MFP devices to check their current status. If a problem is detected, the PAU may send an alert via email to an administrator or dealer. However, this current method of implementing PAUs is limited in that it only checks on physical MFP devices.

Web services provide automatic link checking of web sites. These services, generally free of charge to a user, take as input a set of web sites. The service then periodically checks the hyperlinks in the web site and searches which hyperlinks are “dead links” (i.e., non-responding hyperlinks). After checking each hyperlink in the web sites, the web service sends an email to the owner of the web site identifying which web sites include dead links. However, this current method of implementing web services is also limited in that it is limited to web sites only and is further limited to only checking whether dead links are included in a web site.

The present systems and methods provide an effective method for periodic checking of web services registered for a set of MFP devices. The present systems and methods validate the interface, language, format, semantics, access rights, etc. of the web services registered to the set of MFP devices. If a problem is encountered during the periodic check, a detailed report may be generated.

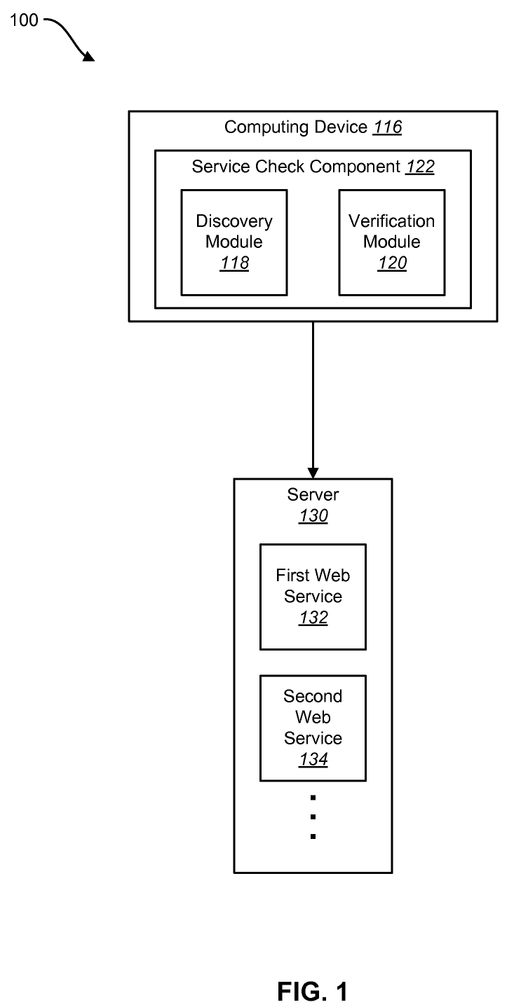

FIG. 1 is a block diagram 100 illustrating one embodiment of a computing device 116 including a service check component 122 in accordance with the present systems and methods. The service check component 122 may include a discovery module 118. The discovery module 118 may discover the physical MFP devices within a certain network and which services (hosted by a server 130) are utilized by each discovered MFP device. This discovery information may be retained for periodic verification. A verification module 120 may execute periodic verification, as will be discussed below.

In one embodiment, the server 130 includes a first web service 132 and second web service 134. The server 130 may include more or less than two web services. The first web service 132 may be registered with an MFP device. In addition, the second web service 134 may be registered with an MFP device. The computing device 116 may implement the service check component 122 to discover the physical MFP devices within a network and which MFP devices utilize the first web service 132 and the second web service 134. In one embodiment, the computing device 116 is an MFP device that utilizes a service hosted by the server 130.

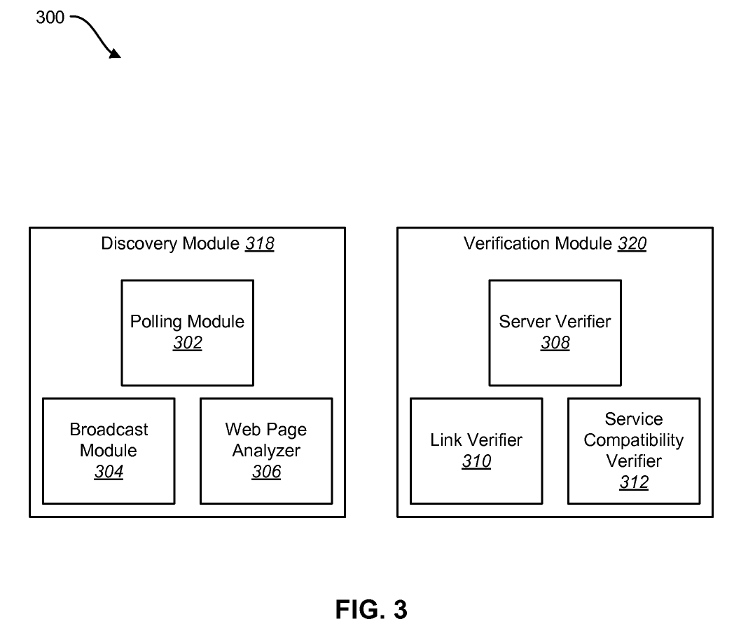

The verification module 120 may perform periodic checks of the server 130 and the services 132, 134 hosted by the server 130. Each periodic check may include three phases. The three phases may be a hosting server check, a link check and a service compatibility check. These three phases will be further discussed below in relation to FIG. 3.

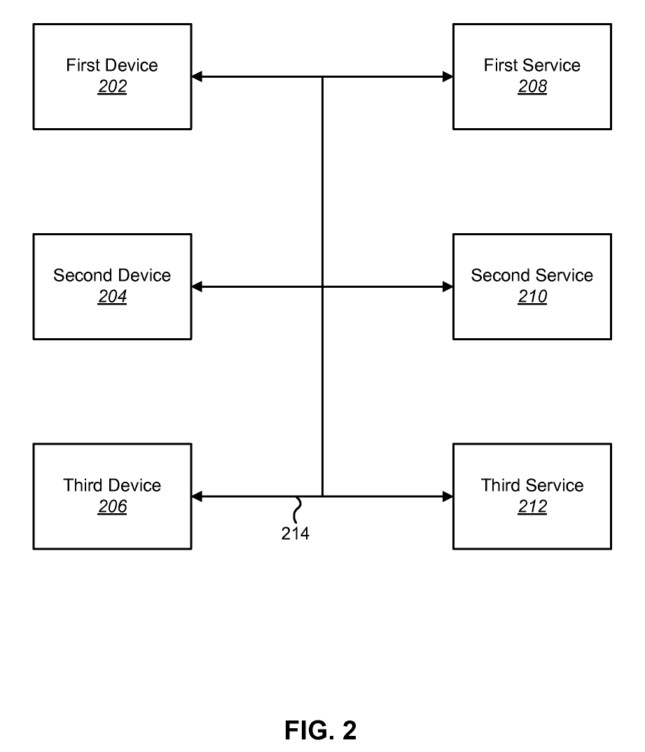

FIG. 2 illustrates one embodiment of an operating environment of the present systems and methods. The operating environment may include one or more devices 202, 204, 206 which may directly utilize an external service 208, 210, 212. In another embodiment, a device may be under the control of an external service. The devices 202, 204, 206 may be MFP devices. The services 208, 210, 212 being utilized by the devices may augment the functionality of the devices. Some examples of the external services 208, 210, 212 may include queue/job management, input/output format conversion, user interface (UI), language translation, output augmentation (e.g., bates stamping, optical character recognition (OCR)), access control, job accounting, auditing, virus/malware checking, etc.

The external services 208, 210, 212 may be communicatively coupled to the devices 202, 204, 206. The external services 208, 210, 212 may be any kind of service, such as a web service, a Sharp OSA application, a Canon Multi-functional Embedded Application Platform (MEAP) application, etc. Communication and transport of data to/from the devices 202, 204, 206 and the external services 208, 210, 212 may be executed by any protocol 214 or combination of protocols. Examples of possible protocols 214 (or combinations thereof) may include web service/Service Oriented Architecture Protocol (SOAP), SOAP/XML, Direct Internet Message Encapsulation (DIME), File Transfer Protocol (FTP), Network File System (NFS), Simple Mail Transfer Protocol (SMTP), Hypertext Transfer Protocol (HTTP)/Hypertext Markup Language (HTML), proprietary protocol over Transmission Control Protocol (TCP)/Internet Protocol (IP), Short Messaging System (SMS), Multimedia Messaging System (MMS), Apple Talk, etc.

Additionally, the external services 208, 210, 212 may be registered or otherwise associated with the devices 202, 204, 206. In one embodiment, the external services 208, 210, 212 may be registered in a device or an external service directory (e.g., Microsoft Directory Services). The services may be registered via a web page interface or via a programmatic interface.

The devices 202, 204, 206 may be any type of MFP device. Examples of the devices 202, 204, 206 include, but are not limited to, a printer, scanner, copier, filing device, facsimile device, web publishing device, format converter, language translator, display device, audio/video record/playback, digital media duplication device, electronic smart board, etc.

FIG. 3 is a block diagram 300 illustrating a further embodiment of a discovery module 318 and a verification module 320. The discovery module 318 may be implemented to discover the services registered/associated with each MFP device. The discovered information may be stored in a persistent repository, such as a database, registry or file. The discovery module 318 may include a polling module 302 that polls each MFP device to discover the devices located in a certain network. The polling module 302 may also poll the devices to discover which services are registered/associated with the devices. The discovery module 318 may also include a broadcast module 304 which may be implemented to broadcast discovery requests to the devices. In another embodiment, the broadcast module 304 multicasts the discovery requests to the devices (e.g., WS-Discovery). A web page analyzer 306 may also be implemented to discover information from a web page associated with an MFP device. In addition, discovery information may also be provided by manual entry from a user.

The verification module 320 may be utilized to perform a periodic service check of the validity of each of the registered/associated services per MFP device. In one embodiment, the services are registered/associated with more than one MFP device and each of the devices has compatible conformance requirements for the service. The service check may be applied once for the service.

The service check may be applied on any interval. For example, the check may be performed on a periodic interval (e.g., once a month). In addition, the check may be manually initiated. Further, the occurrence of the service check may be event driven (e.g., when a new device is added to a network). The verification module 320 may be implemented as software or firmware and may reside on a computing device within a local network, a computing device outside the local network (e.g., a web site) or within an MFP device or a different MFP device being checked. The service check performed by the verification module 320 may be a standalone process or part of another application, such as a device management application. As previously explained, the service check may include three phases, the hosting server check, the link check and the service compatibility check.

A server verifier 308 may perform the hosting server check. The hosting server check may include verifying the validity of the hosting server 130. This check may be performed for servers within the communicative network of the MFP devices. The hosting server check may verify if the server 130 is operational and if an MFP device has access rights to the server 130. If a problem is detected, a notification may be sent to an administrator.

If the hosting server check succeeds, a link verifier 310 performs the link check phase. The link check phase verifies the validity of the link to a service 132, 134 on the server 130. The link check may include verifying that the link exists, the access rights to the link and that the application or process associated with the link can be initiated. If a problem is detected, a notification may be sent to an administrator.

If the link check is successful, a service compatibility verifier 312 verifies that the service 132, 134 is compatible with an MFP device. This check may include a syntax check that verifies that the commands (e.g., Extensible Markup Language (XML) tags) are within the language supported by the MFP device. The service compatibility check may also include an interface check that verifies that the server 132, 134 interface is supported and operable by the MFP device. Further, the service compatibility check may include a semantics check that verifies that the structure of the interface of the service 132, 134 is operationally compatible with the MFP device. If a problem is detected, a notification may be sent to an administrator.

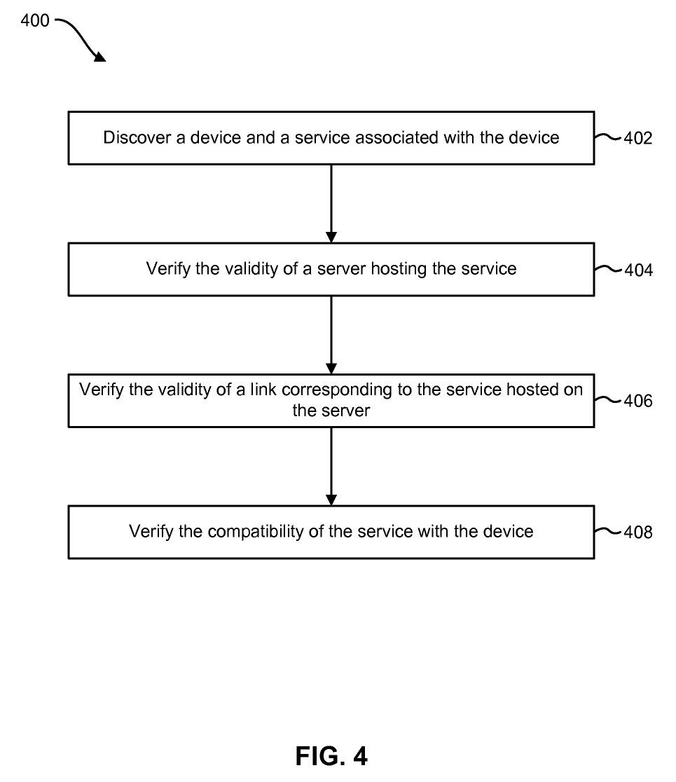

FIG. 4 is a flow diagram illustrating one embodiment of a method 400 for managing a service registered on a device. The method 400 may be implemented by a device that includes the discovery module 318 and the verification module 320. In one embodiment, a device and a service associated with the device are discovered 402. This may be accomplished by polling each device within a network. Broadcast or multicast discovery may also be implemented. In addition, information from a web page associated with the device may be analyzed.

The validity of a server hosting the service may be verified 404. Verification is made as to whether a server is operational and if a device has access rights to the server. In addition, the validity of a link corresponding to the service may also be verified 406. For example, a verification may be made as to whether the link exists. Access rights to the link may also be verified. Further, application or processes associated with the link may be verified to start up upon request.

The compatibility of the service with the device may be verified 408. A syntax check may be implemented to verify that the commands are within the language supported by the device. In addition, an interface check may verify that the service interface is supported and operable by the device. Further, a semantics check may verify that the structure of the interface is operationally compatible with the device.

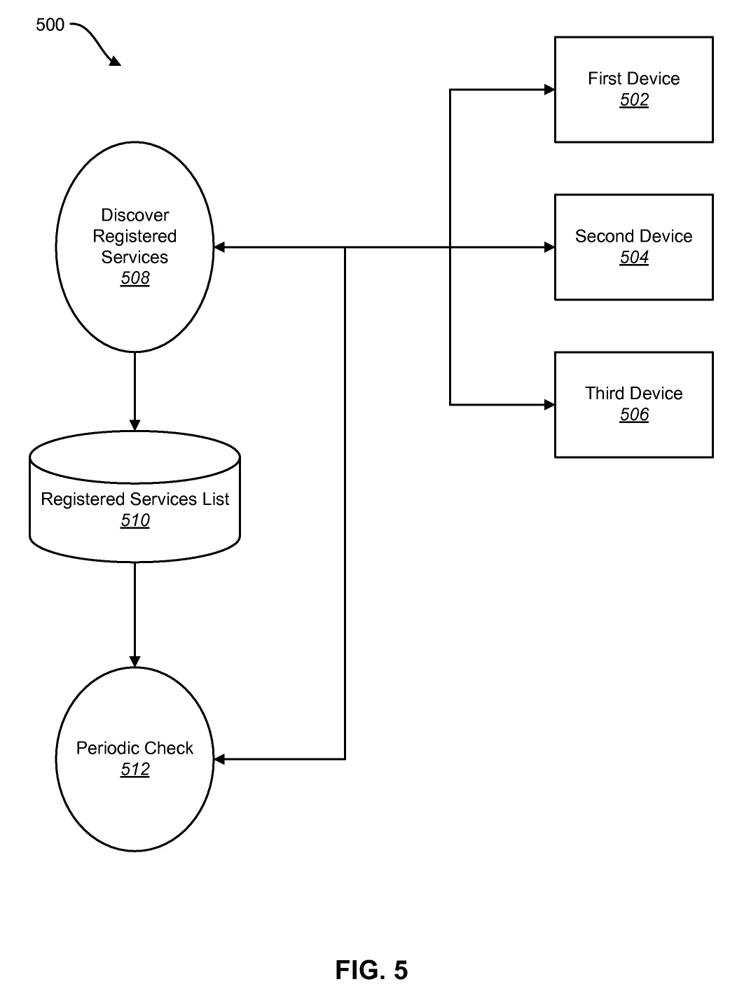

FIG. 5 is a diagram illustrating a process 500 of performing a service check. The process 500 may be implemented by the discovery module 318 and the verification module 320. The process 500 may be accomplished by performing a periodic check 512 of devices 502, 504, 506 within a network and the services registered on the devices. Registered services may be discovered 508. These services may be registered on a first device 502, a second device 504 or a third device 506. The discovered services may be stored in a registered services list 510. The periodic check 512 may verify the operation and status of the devices 502, 504, 506 and services.

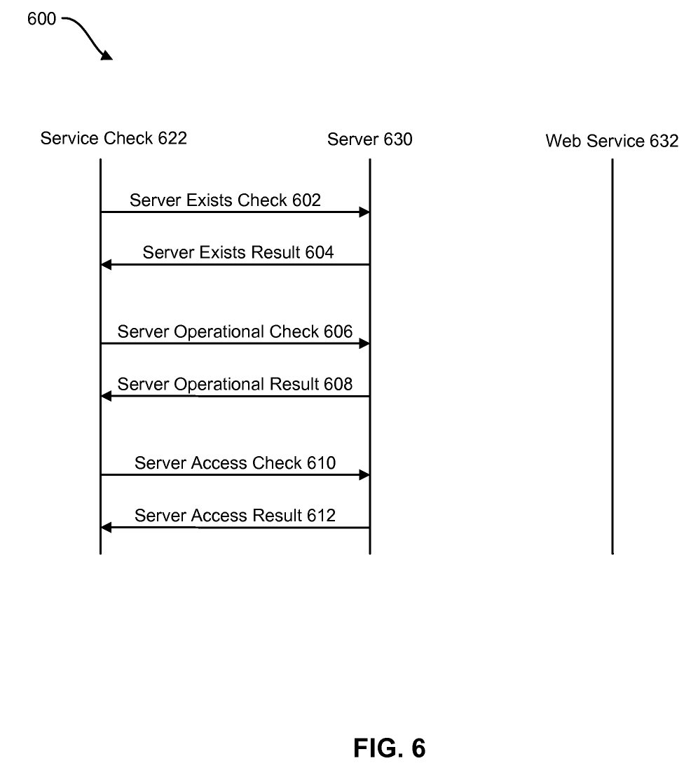

FIG. 6 is a thread diagram 600 illustrating one embodiment of a service check 622 to periodically check the status of a server hosting a service. The service check 622 may be implemented by the server verifier 308. The service check verifies the hosting server is accessible from the network that includes the devices, such as MFP devices. In other words, a server exists check 602 is sent to the hosting server 630 to verify if the server 630 exists within the same network as the device. For example, if the MFP device is within a closed local area network (LAN) protected by a firewall, the hosting server 630 should be within the firewall. Alternatively, if the MFP device is on a cell network, the hosting server 630 should be on a network accessible to the cell network. A server exists result 604 is sent back to the entity performing the service check 622 (e.g., the server verifier 308). Alternatively, if the MFP device is within a LAN protected by a firewall, and the hosting server 630 is on a wide area network (WAN), such as the Internet or another LAN protected by another firewall, a communication link should exist through the firewall.

If an access problem is encountered during the network access check, the server verifier 308 may record the reason(s) for failure and terminate the service check 622. The verifier 308 may also send notifications to destinations registered to receive service check notifications. These destinations may include a network administrator, an owner of the device or service, a dealer leasing the device or service, etc. The server verifier 308 may also instruct the MFP device to unregister or otherwise disable the service access, and/or use an alternate service in its place.

The service check 622 may verify that the hosting server 630 is operational. A server operational check 606 may be sent to the server 630. In one embodiment, the server operational check 606 is implemented by attempting to connect to the server 630 by a protocol/message, such as an Internet Control Message Protocol (ICMP) ping. If the server 630 responds with a server operational result 608 within some time period, the server 630 is assumed to be operational; otherwise, the server 630 is assumed to be non-operational. If an operational problem is encountered, the service check 622 may do one or more of the aforementioned error responses, and the service check 622 is terminated.

The service check 622 may also verify that the device has access rights to the server 630. A server access check 610 may be sent to the server 630. This may be done by any means, such as checking or inquiring on an access control list/rights for the MFP device to the server 630. A server access result 612 may be provided to the entity performing the service check 622. If an access problem is encountered, the service check 622 may do one or more of the aforementioned error responses and the service check 622 may be terminated.

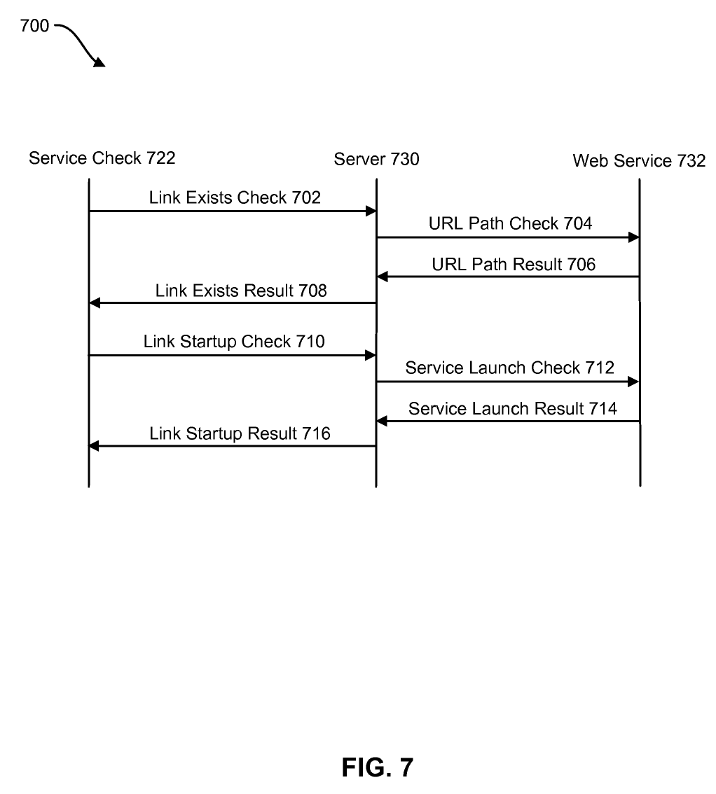

FIG. 7 is a thread diagram 700 illustrating one embodiment of a service check 722 that implements a link check. The service check 722 may verify that the link (i.e., the Uniform Resource Locator (URL)) associated with the service hosted on a server 730 does exist on the hosting server 730. A link exists check 702 may be sent to the server 702. The check 702 may be implemented by any means, such as requesting the link (e.g., HTTP get) from the hosting server 730. A URL path check 704 may then be sent to a web service 732 to verify the existence of the link. A URL path result 706 may be provided to the server 730 and, based upon the result, a link exists result 708 is provided to the service check 722. If the request fails (i.e., the link exists check 702 or the URL path check 704), the service check 722 may request the reason for failure, such as a “not found error.” If a link existence problem is encountered, the service check 722 may do one or more of the aforementioned error responses, and the service check 722 may be terminated.

In another embodiment, the service check 722 verifies that the MFP device has access rights to the service on the hosting server 730. This may be done by any means, such as checking or inquiring on an access control list/rights for the MFP device to the service. If an access problem is encountered, the service check 722 may do one or more of the aforementioned error responses and the service check 722 may be terminated.

The service check 722 may also verify that the application (e.g., code back) associated with the link can be started up. A link startup check 710 may be sent to the server 730. This check 710 may be implemented by any means, such as checking for an application related failure when accessing the link. A service launch check 712 may be sent to the web service 732 and if the application associated with the link is executed, a positive service launch result 714 is provided to the server 730. A link startup result 716 is also provided to the service check 722 based upon the service launch result 714.

If an application startup problem is encountered, the service check 722 may do one or more of the aforementioned error responses, and the service check 722 may be terminated.

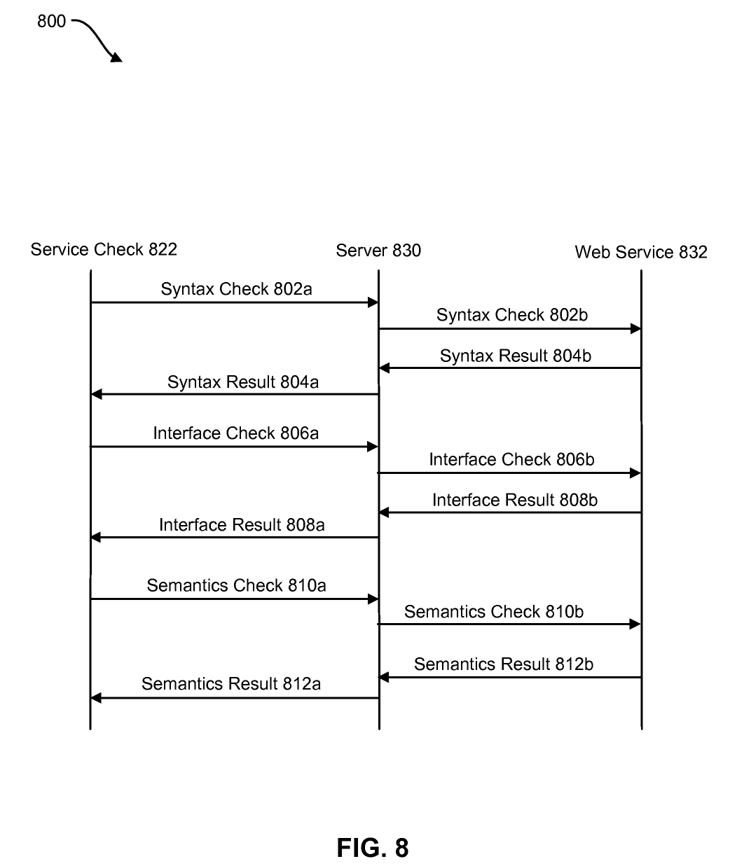

FIG. 8 is a thread diagram 800 illustrating a service check 822 performing a site compatibility check. In one embodiment, the service check 822 examines the entry and possibly each link (e.g., web page) associated with the service 832. The contents of the links are parsed according to the service language formats, or subsets of, supported by the device. Some examples include HTML, Common Cascading Style Sheets (CSS), XML, Wireless Markup Language (WML), Extensible HyperText Markup Language (xHTML), etc.

A syntax check 802a, 802b is then performed on the parsed elements to determine if all the elements parsed are supported by the device (i.e., within the device's language scope). Some examples include keyword recognition, keyword pairing (start/end elements), sentence structure, etc. A syntax result 804a, 804b may be provided to the service check 822 to indicate whether a syntax problem was encountered. If a syntax problem is encountered, the service check 822 may do one or more of the aforementioned error responses, and the service check 822 may be terminated.

An interface check 806a, 806b may be provided to check whether the interface per entry is compatible or all links are compatible with the MFP device. For example, the MFP device may expect that the entry page is a login page or a web page built using one of a specific set of templates. The service 832 may determine this by any means, such as looking for a particular template construction, looking for use of a particular keyword or sequence of keywords, etc. An interface result 808a, 808b is provided to indicate whether interface errors were encountered. If an interface problem is encountered, the service check 822 may do one or more of the aforementioned error responses, and the service check 822 may be terminated.

A semantics check 810a, 810b may also be provided. This check 810a, 810b may be provided per entry or for all links to verify compatibility with the MFP device. A semantics check 810a, 810b may include range check on variables, number/type of input boxes, required/excluded constructs, input data lengths, etc. A semantics result 812a, 812b may also be provided to indicate whether problems concerning the semantics check 810a, 810b were encountered. If a semantics problem is encountered, the service check 822 may do one or more of the aforementioned error responses, and the service check 822 may terminate.

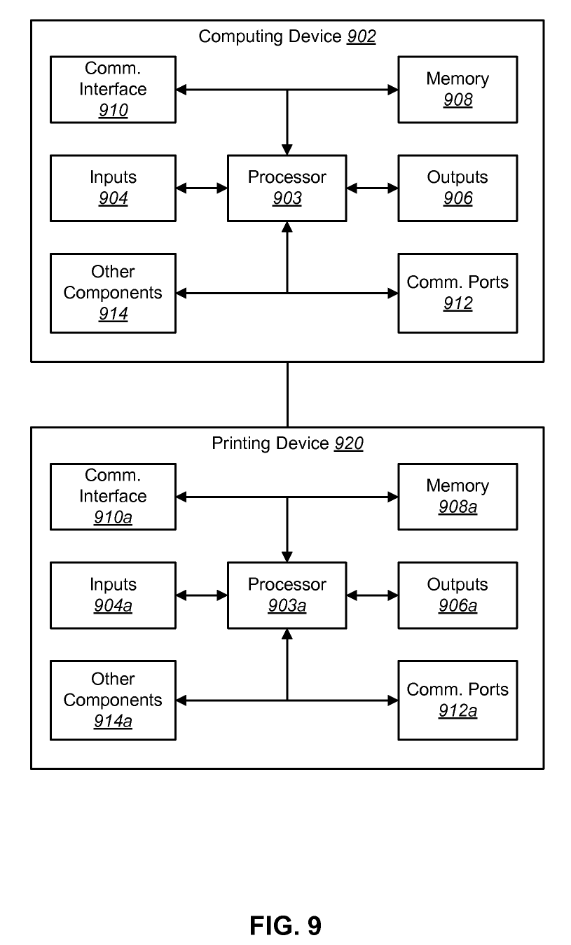

FIG. 9 is a block diagram illustrating the major hardware components typically utilized with embodiments herein. The systems and methods disclosed may be used with a computing device 902 and a printing device 920. The major hardware components typically utilized in a computing device 902 are illustrated in FIG. 9. A computing device 902 typically includes a processor 903 in electronic communication with input components or devices 904 and/or output components or devices 906. The processor 903 is operably connected to input 904 and/or output devices 906 capable of electronic communication with the processor 903, or, in other words, to devices capable of input and/or output in the form of an electrical signal. Embodiments of devices 902 may include the inputs 904, outputs 906 and the processor 903 within the same physical structure or in separate housings or structures.

The computing device 902 may also include memory 908. The memory 908 may be a separate component from the processor 903, or it may be on-board memory 908 included in the same part as the processor 903. For example, microcontrollers often include a certain amount of on-board memory.

The processor 903 is also in electronic communication with a communication interface 910. The communication interface 910 may be used for communications with other devices 902, printing devices 920, servers, etc. Thus, the communication interfaces 910 of the various devices 902 may be designed to communicate with each other to send signals or messages between the computing devices 902.

The computing device 902 may also include other communication ports 912. In addition, other components 914 may also be included in the computing device 902.

Many kinds of different devices may be used with embodiments herein. The computing device 902 may be a one-chip computer, such as a microcontroller, a one-board type of computer, such as a controller, a typical desktop computer, such as an IBM-PC compatible, a Personal Digital Assistant (PDA), a Unix-based workstation, etc. Accordingly, the block diagram of FIG. 9 is only meant to illustrate typical components of a computing device 902 and is not meant to limit the scope of embodiments disclosed herein.

The computing device 902 is in electronic communication with the printing device 920. A printing device 920 is a device that receives or transmits an imaging job, such as a Multi-Function Peripheral (“MFP”) or computing device. Printing devices include, but are not limited to, physical printers, multi-functional peripherals, a printer pool, a printer cluster, a fax machine, a plotter, a scanner, a copier, a logical device, a computer monitor, a file, an electronic whiteboard, a document server, a filing device, display device, audio/visual recorder/player, a media duplication device, etc. A typical printing device, such as a physical printer, fax machine, scanner, multi-functional peripheral or copier is a type of computing device. As a result, it also includes a processor, memory, communications interface, etc., as shown and illustrated in relation to FIG. 9. The printing device may be a single or a plural grouping (e.g., pool or cluster) of two or more devices.

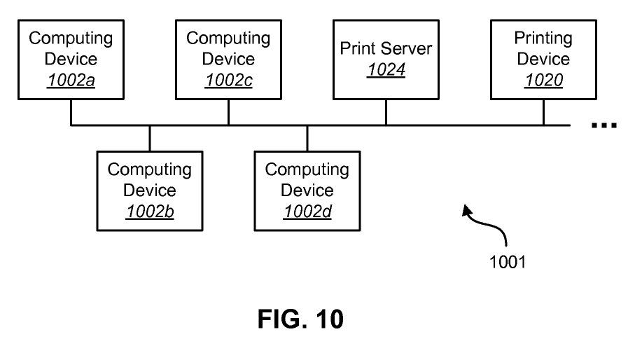

FIG. 10 is a network block diagram illustrating one possible environment in which the present systems and methods may be implemented. The present systems and methods may also be implemented on a standalone computer system. FIG. 10 illustrates a computer network 1001 comprising a plurality of computing devices 1002, a printing device 1020 and a print server 1024.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described in connection with the embodiments disclosed herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

Functions such as executing, processing, performing, running, determining, notifying, sending, receiving, storing, requesting, and/or other functions may include performing the function using a web service. Web services may include software systems designed to support interoperable machine-to-machine interaction over a computer network, such as the Internet. Web services may include various protocols and standards that may be used to exchange data between applications or systems. For example, the web services may include messaging specifications, security specifications, reliable messaging specifications, transaction specifications, metadata specifications, XML specifications, management specifications, and/or business process specifications. Commonly used specifications like SOAP, WSDL, XML, and/or other specifications may be used.

While specific embodiments have been illustrated and described, it is to be understood that the claims are not limited to the precise configuration and components illustrated above. Various modifications, changes and variations may be made in the arrangement, operation and details of the embodiments described above without departing from the scope of the claims.

What is claimed is:

1. A method for managing a service registered on a device, comprising:
discovering a device and a service associated with the device;
verifying the validity of a server hosting the service;
verifying the validity of a link corresponding to the service hosted on the server; and
verifying the compatibility of the service with the device.

2. The method of claim 1, wherein verifying the validity of the server hosting the service comprises verifying that the server hosting the service is accessible from a network comprising the device.

3. The method of claim 1, wherein verifying the validity of the server hosting the service comprises verifying that the server hosting the service is operational.

4. The method of claim 1, wherein verifying the validity of the server hosting the service comprises verifying that the device has access rights to the server hosting the service.

5. The method of claim 1, wherein verifying the validity of the link corresponding to the service comprises verifying that the link exists on the server hosting the service.

6. The method of claim 1, wherein verifying the validity of the link corresponding to the service comprises verifying that the device has access rights to the service that is hosted on the server.

7. The method of claim 1, wherein verifying the validity of the link corresponding to the service comprises verifying that an application associated with the link can be initiated.

8. The method of claim 1, wherein verifying the compatibility of the service with the device further comprises parsing the contents of the link according to one or more service language formats supported by the device.

9. The method of claim 1, wherein verifying the compatibility of the service with the device further comprises performing a syntax check on the passed contents to determine if the parsed contents are supported by the device.

10. The method of claim 1, wherein verifying the compatibility of the service with the device further comprises verifying that an interface of the link is compatible with the device.

11. The method of claim 1, wherein verifying the compatibility of the service with the device further comprises performing a semantics check on the link to verify compatibility with the device.

12. The method of claim 1, wherein the device is a multifunction peripheral (MFP).

13. The method of claim 1, wherein the service is a web service.

14. A computing device that is configured to manage a service registered on the computing device, the computing device comprising:
a processor;
memory in electronic communication with the processor;
instructions stored in the memory, the instructions being executable to:
discover a device and a service associated with the device;
verify the validity of a server hosting the service;
verify the validity of a link corresponding to the service hosted on the server; and
verify the compatibility of the service with the device.

15. The computing device of claim 14, wherein the instructions are further executable to verify that the server hosting the service is accessible from a network comprising the device.

16. The computing device of claim 14, wherein the instructions are further executable to verify that the server hosting the service is operational.

17. The computing device of claim 14, wherein the instructions are further executable to verify that the device has access rights to the server hosting the service.

18. The computing device of claim 14, wherein the instructions are further executable to verify that the link exists on the server hosting the service.

19. The computing device of claim 14, wherein the instructions are further executable to verify that the device has access rights to the service that is hosted on the server.

20. The computing device of claim 14, wherein the instructions are further executable to verify that an application associated with the link can be initiated.

21. The computing device of claim 14, wherein the instructions are further executable to parse the contents of the link according to one or more service language formats supported by the device.

22. The computing device of claim 21, wherein the instructions are further executable to:
perform a syntax check on the passed contents to determine if the parsed contents are supported by the device;
verify that an interface of the link is compatible with the device; and
perform a semantics check on the link to verify compatibility with the device.

23. The computing device of claim 14, wherein the computing device is a multifunction peripheral (MFP) device.

24. The computing device of claim 14, wherein the service is a web service.

25. A computer-readable medium comprising executable instructions for:
discovering a device and a service associated with the device;
verifying the validity of a server hosting the service;
verifying the validity of a link corresponding to the service hosted on the server; and
verifying the compatibility of the service with the device.
